(19) United States
(12) Patent Application Publication
(10) Pub. No.: US 2026/0356323 A1
(43) Pub. Date: Nov. 12, 2026

(54) Method and Apparatus for Providing a Remote Control Function of a Vehicle

(71) Applicant: Bayerische Motoren Werke Aktiengesellschaft, Muenchen (DE)

(72) Inventors: Alaa MOURAD, Muenchen (DE); Thomas WURSTHORN, Muenchen (DE)

(21) Appl. No.: 19/134,435

(22) PCT Filed: Nov. 8, 2023
(86) PCT No.: PCT/EP2023/081159

§ 371 Date: May 30, 2025

(30) Foreign Application Priority Data
Jan. 13, 2023 (DE) 10 2023 100 792.0

(51) Int. Cl. B60R 25/24; B60R 25/102; G08C 17/02

(52) U.S. Cl. CPC B60R 25/24; B60R 25/102; G08C 17/02; G08C 2201/60

(57) ABSTRACT

An apparatus provides a remote control function of a vehicle. The remote control function is controlled via a communication connection between the vehicle and a device. The apparatus determines that there is an impairment in the communication connection and, in response, causes the remote control function and the control communication between the device and the vehicle to be interrupted. The apparatus detects that one or more continuation conditions for continuing the remote control function have been met and, in response, causes the remote control function and the control communication between the device and the vehicle to be continued.

### BACKGROUND AND SUMMARY

The invention relates to a method and corresponding apparatus with which a reliable and effective remote control function for a vehicle can be obtained.

A vehicle can be equipped with a digital access and/or control system with which a user can use an electronic device such as a smart phone that has a digital vehicle key for controlling one or more of the vehicle's remote control functions. By way of example, the electronic device can be used to control and/or monitor an automated parking maneuver by the vehicle.

The present application deals with the technological problem of enabling a particularly reliable and effective remote control of an automated parking maneuver.

This problem is addressed by the subject matter disclosed herein in connection with the one or more embodiments described. It should be noted that supplementary features in any of the dependent claims could form an independent invention, independently of the combination of all of the features of the independent claim, without the features of the independent claim, or in combination with only part of the features of the independent claim, which could form the subject matter of an independent claim, a subsidiary application, or a subsequent application. This also applies to technical teachings in the description that could form an invention independently of the features of the independent claims.

One aspect of the invention relates to an apparatus with which a remote control function for a (motor) vehicle is obtained. The remote control function can comprise longitudinal and/or lateral control of the vehicle. The remote control function can specifically be an automated parking maneuver.

This remote control function can be controlled through a communication connection between the vehicle and an (external) operator device. The device can be a mobile and/or electronic (user's) device (e.g. a smartphone or smart device). The device can contain a digital key in accordance with a Car Connectivity Consortium (CCC) standard, in particular in accordance with the CCC Release 3 Standard. The digital key can be configured to allow the device to implement the vehicle's remote control function. The communication connection can be a Bluetooth Low Energy (BLE) communication connection.

The apparatus can be configured to repeatedly receive or send a message periodically (e.g. every 100 ms) in the framework of the communication between the device and the vehicle. The individual messages can contain control data for the remote control function and/or information (e.g. round trip time (RTT)) indicating the quality of the communication connection. By repeatedly sending and/or receiving messages through the communication connection, it is possible to obtain a reliable and secure control of the remote control function.

The apparatus can also be configured to check whether a message received in the framework of the control communication between the device and the vehicle has been corrupted or not. This can be checked using a cyclic redundancy check (CRC), for example. The apparatus can also be configured to request the message be resent if it has been determined that the received message has be corrupted. The messages can be resent at a specific frequency (e.g. every 30 ms). It is possible to increase the reliability of the remote control function for the vehicle by resending corrupted messages.

One or more disrupters in the vehicle's and/or device's environment can result in corruption of the periodically sent messages, resulting in resending messages and thus increasing the load to the communication connection. This can result in an exponential increase in messages and a corresponding increase in delays in the exchange of messages. Ultimately, this can result in termination of the remote control function (e.g. if the delay exceeds a specific time period).

The apparatus is configured to determine (when executing and/or controlling the remote control function, and/or prior to interruption of the remote control function) if the communication connection, in particular the control communication, has been corrupted. The apparatus can be configured to (potentially repeatedly) determine one or more indicators that the control communication connection has been corrupted. These indicators provide a precise way to determine whether the control communication has been corrupted.

These indicators can be
a delayed message in the framework of the control communication (for the remote control function), in particular a delay exceeding the delay threshold length; i.e. it is possible to determine if one of the messages has been excessively delayed; and/or
a number and/or frequency of repeated transmissions of messages in the framework of the control communication, in particular a number and/or frequency exceeding a threshold value; this allows for detection of extremely frequent “retransmissions” of messages; and/or
corruption of a control message received through the communication connection, e.g. an error in the cyclic redundancy check (CRC); and/or
the amount of data in a buffer for sending control messages, in particular if this exceeds a threshold value; e.g. it can be determined whether there is too much data for the buffer (in particular due to “retransmissions”). resulting in excessive delays.

Corruptions in the control communication connection can be detected before they cause termination of the remote control function. This type of termination can occur, for example, if no response to a query has been received within a predefined time period (e.g. 500-600 ms) for one of the communication partners (e.g. the vehicle). This corruption in the communication connection can thus be detected prior to the end of the termination period.

The apparatus is also configured to interrupt remote control and control communication between device and the vehicle if the control communication connection in particular is corrupted. The control communication and/or remote control function can be interrupted automatically in this case, in particular without a user's intervention. This prevents repeated, periodic reception or sending of messages. Furthermore, repeated transmission of a corrupted message can also be prevented. This interrupts the (potentially exponentially increasing) message traffic in the control communication.

The interruption of the control communication can reduce data traffic in the frequency range for the communication connection and/or data traffic through the communication connection, in order to resolve the corruption in the communication connection.

The vehicle can also be stopped (thus interrupting the remote control thereof). The user can also be notified of this through a user interface.

The apparatus is also configured to detect when one or more continuation conditions have been met for the remote control function. It is possible to check repeatedly and/or automatically whether these one or more continuation conditions have been met. The one or more continuation conditions for the remote control function can be
a minimum or exact interruption period starting when the remote control function and/or control communication was interrupted; and/or
a maximum amount of data in the buffer for transmitting messages for control communication.

It is therefore possible to wait until a specific interruption period has elapsed, and/or until the data buffer has enough available space.

The apparatus is also configured to resume the remote control function and control communication between the device and the vehicle (automatically, in particular without intervention by the user).

This results in an apparatus (for the device and/or for the vehicle) that detects whether the control communication through the communication connection has been corrupted prior to termination of the remote control function. The remote control function is then interrupted in order to repair the communication connection and thus prevent an irreversible termination in the remote control function. This results in a particularly effective and reliable operation of the remote control function.

Another aspect of the invention relates to a (mobile and/or electronic) user device (e.g. smartphone or general smart device) for a (motor) vehicle user. The user device can contain a digital key for an access and/or control system for the (motor) vehicle (which is stored in a protected memory in the user device). The user device can be used to control one or more vehicle functions with the digital key, in particular a remote control function for the vehicle. The user device also contains the apparatus described in this application (e.g. in the form of a software application).

Another aspect of the invention relates to a (street) motor vehicle (in particular a passenger automobile, truck, bus, or motorcycle), that has the apparatus described in this application. The vehicle can also have an access and/or control system that allows a user to control one or more vehicle functions (in particular a remote control function, e.g. automated longitudinal and/or lateral control of the vehicle) using a (mobile, electronic) device that contains a digital key.

Another aspect of the invention relates to a method for implementing a remote control function (in particular a remote parking function) in a (motor) vehicle. The remote control function can be controlled through a communication connection between the vehicle and a (user) device (through repeated, in particular periodic, exchange of messages).

The method comprises determining if the communication connection, in particular the control communication for controlling the remote control function, has been corrupted, and interrupting the remote control function and control communication between the device and the vehicle in response thereto. The method also comprises (automatic) detection that one or more continuation conditions for resuming the remote control function have been met, and to (automatically) resume the remote control function and control communication between the device and the vehicle in response thereto.

Another aspect of the invention relates to a software program. This program can be executed on a processor to carry out the process described in this application.

Another aspect of the invention relates to a memory. The memory can contain software with which the processor can carry out the method described in this application.

It should be noted that the methods, apparatuses, and systems described in this application can be used not only alone, but also in combination with other methods, apparatuses, and systems described in this application. Moreover, all of the aspects of the methods, apparatuses and systems described herein can be combined in numerous ways with one another. In particular, features in the claims can be combined in numerous ways with one another. Any features in parentheses are understood to be optional.

The invention shall be explained in greater detail below based on exemplary embodiments.

### BRIEF DESCRIPTION OF THE DRAWINGS

FIG. 1a shows an exemplary digital access and/or control system for a vehicle;

FIG. 1b shows an exemplary situation in which a digital access and/or control system is used;

FIG. 2 shows exemplary communication between a vehicle and a device for controlling a vehicle function; and

FIG. 3 shows a flow chart for an exemplary method for implementing a remote control function for a vehicle.

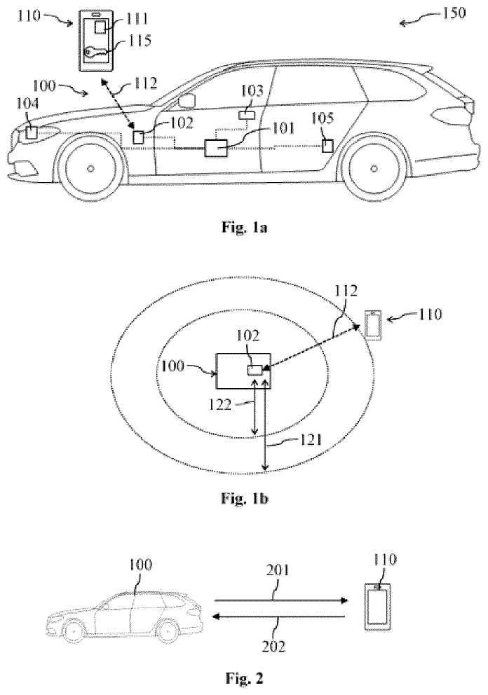

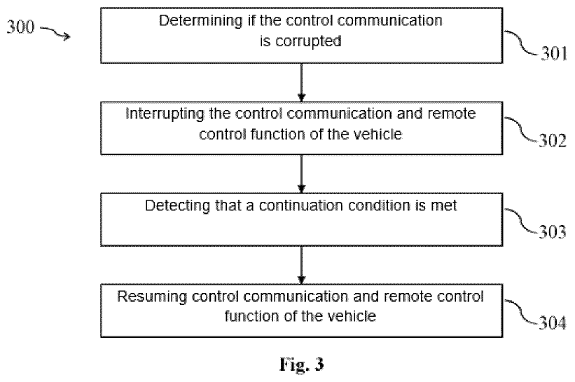

### DETAILED DESCRIPTION OF THE DRAWINGS

As explained above, the present application relates to increasing the conveniency, reliability and/or effectiveness of a remote control function for a vehicle. FIG. 1a shows an exemplary (access and/or control) system 150, comprising a vehicle 100 and at least one digital key device 110. The digital key device 110 is typically a portable electronic device, e.g. a smartphone or computer tablet, that contains a digital key 115. The digital key 115 can be stored in a protected memory, in particular a so-called “secure element,” in the portable electronic device (e.g. for the user).

The digital key device 110, in particular a (control) apparatus 111 for the device 110, is designed to communicate with a communication unit 102 in the vehicle 102 through one or more different wireless communication connections 112. The different communication connections 112 can be used for different purposes. In particular, a Bluetooth Low Energy (BLE) communication connection 112 can be used, to
determine the distance and/or relative position between the digital key device 110 and the vehicle 100 (in particular based on the signal strength, in particular the received signal strength indicator (RSSI), for the wireless signals exchanged between the vehicle 100 and the device 110); and/or
exchange control data between the digital key device 110 and the vehicle 100 (e.g. a control command for a vehicle function 103, e.g. unlocking doors, and/or opening or closing windows, and/or activation or deactivation of a heating function, and/or activation or deactivation of vehicle's motor, and/or an automated parking maneuver).

An ultra-wideband (UWB) communication connection 112 could also be used to relatively precisely determine the position of the device 110 in relation to the vehicle 100. This determination of the position of the device 110 using the UWB communication connection 112 can be referred to as UWB ranging.

A (control) apparatus 101 for the vehicle 100 can be designed to control at least one vehicle function 103, in particular a remote control function for the vehicle 100, based on communication between the device 110 and the vehicle 100, as shown by way of example in FIG. 1b. In this context, the digital key 115 in the device 110 can be verified, in particular authenticated. One or more vehicle functions 103 can then be controlled if the authentication is successful, in particular based on
the distance between the device 110 and the vehicle 100;
the position of the device 110 in relation to the vehicle 100; and/or
a control command sent from the device 110 to the vehicle 100 through a communication connection 112.

In an exemplary system 150, a BLE communication connection 112 can be established between the device 110 and the vehicle 100 as soon as the distance between them is within a threshold distance 121. This allows the user of the device 110 to control one or more vehicle functions 103 remotely. Typically, the vehicle 100 repeatedly indicates that the BLE communication connection 112 is active, e.g. at a specific frequency. Within the first distance threshold 121, the device 110 (which can also be referred to as “user equipment” (UE)) receives a message from the vehicle 100, and the BLE communication connection 112 can be established between the device 110 and the vehicle 100. The first distance threshold 121 can depend on the transmission strength of the device 110, the vehicle's and/or device's environment, and/or the position of the device 110 in relation to the vehicle 100.

A UWB communication connection 112 can also be established between the device 110 and the vehicle 100 as soon as the distance between them is equal to or less than a second distance threshold 122 (which can be less than the first distance threshold 121, and/or can be dependent on the transmission strength of the device 110). The location of the device 110 can be determined relatively precisely with the UWB communication connection 112. One or more other vehicle functions 103 can also potentially be controlled with the UWB communication connection 112 (in addition to the one or more functions 103 that can be controlled through the BLE communication connection 112).

The digital key device 110 can thus be used to control a vehicle function 103 remotely. This vehicle function 103 can be referred to as a remote control function. One example of a remote control function 103 is an automated parking maneuver in which the vehicle 100 is parked automatically in a parking space, or retrieved therefrom. The vehicle 100 may have one or more sensors 104 for this (e.g. at least one radar sensor, at least one camera, at least one lidar sensor, at least one ultrasonic sensor, etc.), each of which is configured to record data relating the vehicle's environment. The (control) apparatus 101 for the vehicle 100 can be configured to operate one or more longitudinal and/or lateral guidance actuators 105 (e.g. a drive motor, steering device, and/or brakes) for the vehicle 100 based on the environmental data, in order to execute the automated parking maneuver.

The vehicle's user can be outside the vehicle 100 during the automated parking maneuver. The device 110 can be used to monitor the automated parking maneuver. In particular, it may be necessary for the user to operate the device 110 during the automated parking maneuver (in general when operating the remote control function 103), to ensure that the user actually monitors the automated parking maneuver.

Messages can be repeatedly, in particular periodically, exchanged between the vehicle 100 and the device 110 in the framework of control communication through a communication connection 112, in particular a BLE communication connection, during a remote control function 103 (e.g. an automated parking maneuver) to ensure that the communication connection 112 for controlling and/or monitoring the remote control function 103 has been established. By way of example, a query 201 can be sent from the vehicle 100 to the device 110 through the communication connection 112. The device 110 can check the query 201 (e.g. using a cyclic redundancy check (CRC) to determine whether the content of the query 201 has been transmitted correctly). The device 110 can also send a response 202 to the vehicle 100, showing the results of the query 201 check.

Queries 201 can be periodically sent from the vehicle 100 to the device 110, and corresponding responses 202 can be sent from the device 110 to the vehicle 100 at a specific frequency (e.g. every 100 ms). The vehicle 100, in particular the apparatus 101 in the vehicle 100, can check whether the communication connection 112 between the vehicle 100 and the device 110 is reliable or corrupted based on the responses 202 that have been received.

Queries 201 can also be repeatedly sent from the device 110 to the vehicle 100. Responses 202 can also be sent from the vehicle 100 to the device 110. This allows the device 110, in particular the (control) apparatus 111 in the device 110, to check whether the communication connection 112 between the vehicle 100 and the device 110 is reliable or corrupted.

If the exchange of messages 201, 202 indicates that the communication connection 112, in particular the control communication, is significantly corrupted (e.g. because no response 202 has been received after a maximum acceptable interruption period (approx. 600 ms)), the remote control function 103 can be terminated. By way of example, the automated parking maneuver can be terminated, and the vehicle 100 can be stopped. This results in a safe execution of a remote control function 103.

During the remote control function 103 (prior to termination thereof), the data exchanged through the communication connection 112 may be slightly corrupted. By way of example, there may be one or more other communication devices near the vehicle 100 and/or device 110 communicating at the same frequency (e.g. 2.4 GHz) as the communication connection 112 between the vehicle 100 and the digital key device 110. These other communication devices may interfere with the communication connection 112 between the vehicle 100 and the digital key device 110, thus corrupting a query 201 and/or response 202.

If a first communication partner (i.e. the vehicle 100 or the device 110) receives a corrupted query 201 or response 202 from the second communication partner, it may request a retransmission of the message 201, 202. The retransmission may be requested at a specific retransmission rate (e.g. 30 ms). Requesting a retransmission further increases data traffic in the frequency range for the communication connection 112, which may result in further corruption.

Furthermore, a query 201 that was sent earlier, during the request for a retransmission, could become the query 201 for the next point in time. This query 201 may also be corrupted, due to the corrupted communication connection 112, potentially resulting in numerous requests for retransmission of this query 201.

An initial (relatively light) corruption of the communication connection 112 can thus result in an exponential increase in the number of requests for retransmission of queries or responses 201, 202, thus overloading the buffer for the communication partner, resulting in an exponential increase in the delay between the query 201 and the corresponding response 202, and ultimately in a termination of the remote control function 103 for the vehicle 100.

A communication partner in the communication connection 112 (i.e. the vehicle 100 and/or device 110) can be configured to detect (before termination of the remote control function 103) that the communication connection 112 has become corrupted while executing a remote control function 103 for the vehicle 100. In particular, it can detect that
the number and/or frequency of requests for retransmission of a query and/or response 201, 202 has increased, and/or exceeded a specific threshold; and/or
the buffer in at least one communication partner is full.

The remote control function 103 may be interrupted in response (by one of the communication partners) to the corruption detected in the communication connection 112. In this case, the vehicle 100 may be brought to a safe state (e.g. stopped). Furthermore, transmission of queries and/or responses 201, 202 may be (temporarily) suspended.

The user of the device 110 may also be informed (e.g. via a user interface in the device 110) that the remote control function has been interrupted. The user may also be informed (after checking for one or more continuation conditions) when the remote control function has been resumed (without the user having to take any action).

After interrupting the remote control function 103 (by one of the communication partners), it is checked whether one or more continuation conditions for resuming the remote control function 103 have been met. Examples of continuation conditions are
lapsing of an interruption period (e.g. 2 seconds) since the interruption of the remote control function 103; and/or
reduction in the amount of data in the buffers of the communication partners to or below a specific threshold level; and/or
reduction in the number and/or frequency of requests for retransmission of a query and/or response 201, 202 to or below a specific threshold.

When it has been detected that one or more continuation conditions have been met, the remote control function 103 can be resumed (automatically). Repeated, periodic transmission of queries 201 can then be resumed. Moreover, the vehicle 100 can move again (to carry out an automated parking maneuver, for example).

The convenience, reliability and effectiveness of a remote control function 103 for a vehicle 100 can be efficiently increased by the automatic interruption and continuation of a remote control function 103, and the associated elimination of corruption in the communication connection 112.

This remote control function 103, in particular the remote parking function 103, can use a pass-through channel for a digital CCC key 115, which uses a BLE connection 112 for the communication between the vehicle 100 and the device 110 to control the remote parking function 103. Data can be continuously transmitted (for queries and/or responses 201, 202) to ensure that the communication is available and/or to exchange control data for the vehicle.

The vehicle 100 can send status reports 201 to the control device 110 at regular intervals, and the control device 110 can respond at regular intervals (with corresponding messages 202) with sensor data and/or control data for the vehicle.

If the transmission environment is overloaded, data transmission through the BLE communication connection 112 may require numerous retransmissions (at a specific retransmission frequency). The combination of BLE message transmissions and relatively frequent retransmissions may fill the message queue at one or both ends of the BLE connection 112 (i.e. at one or both communication partners). The resulting delay increases exponentially, such that the remote control function 103 becomes unavailable for a relatively long period of time, and may become permanently unavailable if interference continues (e.g. in the case of a WLAN).

As explained herein, the BLE master (e.g. the vehicle 100) and/or BLE slave (e.g. the device 110) can take numerous measures to resolve communication problems with the BLE communication connection, e.g. if there are substantial delays in receiving messages 201, 202 due to a full message queue and/or relatively strong interference has been detected. Communication can be resolved by stopping the communication for a defined termination period instead of continuing to send more queries and/or responses 201, 202 (resulting in an exponential increase in delays). The remote control function 103 can thus be interrupted for defined period of time.

If a relatively high communication delay has been detected at the device 110 (e.g. by measuring the round trip time for the BLE messages 201, 202), the device 110 that detected the delay can stop sending messages 201, 202 for a defined time period (e.g. 2 seconds). The message queue can then be processed and/or shortened during this time period. After the termination time period has elapsed, the device 110 can resume sending cyclical messages 201, 202 (to resume the remote control function 103).

FIG. 3 shows a flow chart for an exemplary (computer-implemented) method 300 for obtaining a remote control function 103 through a communication connection 112 between the vehicle 100 and a (mobile and/or electronic) device 110 for controlling the remote control function 103. The device 110 can be outside the vehicle 100 (e.g. at a distance of 1 to 15 meters). The communication connection can be a BLE connection. The remote control function can automatically control the longitudinal and/or lateral movement of the vehicle 100 (e.g. to execute an automated parking maneuver). This may require actuation of an operating element on the device (potentially continuously), to execute the remote control function 100 for the vehicle 100.

The method 300 comprises determining 301 that the communication connection 112, in particular for controlling the remote control function 103, has been corrupted (e.g. because a buffer for the communication between the vehicle 100 and the device 110 is full, and/or because the delay in message transmission has reached or exceeded a specific threshold).

The method 300 also interrupts 302 the remote control function 103 and the communication between the device 110 and the vehicle 100 for controlling the remote control function 103 (temporarily and/or automatically) in response to the determination 301 that the communication connection 112 has become corrupted. The termination can allow for the corrupted communication connection 112 to be repaired.

The method 300 also comprises detection 303 that one or more continuation conditions for resuming the remote control function (103) have been met. At this point, it can be automatically checked (without intervention by the user) whether one or more continuation conditions (such as lapsing of a specific termination period) have been met. This check can be repeated as necessary, in particular periodically.

The method 300 further comprises (automatically) resuming 304 the remote control function 103 and communication between the device 110 and the vehicle 100 for controlling the remote control function 103 in response to the detection 303.

A temporary interruption and subsequent resumption of the remote control function 103 can thus be obtained (instead of a permanent termination of the remote control function 103), in order to repair the communication connection 112. This increases the practicality, reliability, and effectiveness of a remote control function 103.

The present invention is not limited to the exemplary embodiments described herein. It should be noted in particular that the description and drawings are only intended to illustrate the principles of the propose method, apparatuses and systems.

1-12. (canceled)

13. An apparatus for obtaining a remote control function for a vehicle, wherein the remote control function is controlled through a communication connection between the vehicle and a device for controlling the remote control function, the apparatus comprising:
a controller, and
a memory storing software that configures the controller to:
determine when the communication connection is corrupted;
interrupt the remote control function and communication between the device and the vehicle for controlling the remote control function in response to the determination that the communication connection is corrupted;
detect when one or more continuation conditions for resuming the remote control function have been met; and
resume the remote control function and communication between the device and the vehicle for controlling the remote control function.

14. The apparatus of claim 13, wherein the software further configures the controller to:
determine that the communication connection is corrupted based on one or more of the following indicators: delays in receiving messages through the communication connection longer than a threshold period, a number/frequency of retransmissions of messages greater than a threshold number/frequency, corrupted messages received through the communication connection, and/or overloading the buffer for transmitting messages beyond a threshold level.

15. The apparatus of claim 13, wherein the software further configures the controller to:
periodically receive or send messages in the course of communication between the device and the vehicle, wherein the messages contain data for controlling the remote control function and/or for determining the quality of the communication connection; and
stop the periodically receiving or sending of messages in response to determining that the communication connection is corrupted.

16. The apparatus of claim 13, wherein the software further configures the controller to:
in the framework of the control communication between the device and the vehicle, check whether a message is corrupted;
request retransmission of the message if it has been corrupted; and
stop requesting retransmission of a message in response to determining that the communication connection is corrupted.

17. The apparatus of claim 13, wherein the one or more continuation conditions for resuming the remote control function comprise:
a first continuation condition relating to an interruption time period, starting when the remote control function and/or control communication were interrupted; and/or
a second continuation condition relating to a maximum buffer capacity for sending control communication messages.

18. The apparatus of claim 13, wherein the software further configures the controller to:
send a message to a user, through a user interface, indicating that the vehicle function has been interrupted in response to the determination that the communication connection is corrupted.

19. The apparatus of claim 13, wherein the software further configures the controller to:
bring the vehicle to a safe stop in response to the determination that the communication connection is corrupted.

20. The apparatus of claim 13, wherein:
the remote control function comprises an automated parking maneuver for the vehicle,
the communication connection comprises a Bluetooth Low Energy communication connection, and/or
the device contains a digital key according to a Car Connectivity Consortium standard.

21. The apparatus of claim 13, wherein:
the software further configures the controller to automatically interrupt and/or resume control communication and/or the remote control function without intervention by the user, and/or
the interruption of the control communication and/or the remote control function are such that data traffic in the frequency range of the communication connection and/or through the communication connection is reduced to resolve corruption in the communication connection.

22. An operator device for the user of a vehicle, the operator device comprising:
a digital key for an access and/or control system for the vehicle, wherein the operator device can control at least one remote control function for the vehicle using the digital key; and
the apparatus of claim 13.

23. A method for obtaining a remote control function for a vehicle, wherein the remote control function is controlled through a communication connection between the vehicle and a device for controlling the remote control function, the method comprising:
determining that the communication connection is corrupted;
interrupting the remote control function and communication between the device and the vehicle for controlling the remote control function in response to determining that the communication connection is corrupted;
detecting that one or more continuation conditions have been met for resuming the remote control function; and
resuming the remote control function and the communication between the device and the vehicle to control the remote control function in response to the detection.
